(19) United States
(12) Patent Application Publication
(10) Pub. No.: US 2006/0288419 A1
(43) Pub. Date: Dec. 21, 2006

(54) Protection system and method regarding the same

(75) Inventors: George Wang, Chongqing (CN); Pei Hu Lin, Irvine, CA (US)

Correspondence Address: ARENT FOX PLLC, 1050 CONNECTICUT AVENUE, N.W., SUITE 400, WASHINGTON, DC, 20036, US

(73) Assignee: FARSTONE TECH., INC.

(21) Appl. No.: 11/471,715

(22) Filed: Jun. 21, 2006

(30) Foreign Application Priority Data
Jun. 21, 2005 (TW) 94120513

(51) Int. Cl. G06F 12/14

(52) U.S. Cl. 726/24

(57) ABSTRACT

A protection system and methodology that restores a computer to a normal state exactly prior to being infected by virus. According to the invention, protection system is installed in a computer system, having a detecting module. The detecting module detects virus, spyware, Trojan or other security threats. The protection system comprises at least a storage space, a searching module and a backup/recovery module. The storage space is used for recoding a message of operation to a file within the computer system. The searching module is coupled to the storage space. The searching module is used for searching the message of the file. The backup/recovery module is coupled to the searching module. The backup/recovery module is used for restoring the computer system to a previous state in accordance with the message.

### CROSS-REFERENCE TO RELATED APPLICATIONS

This is a 35 U.S.C. § 119 of Taiwan Application No. 94120513 filed Jun. 21, 2005. The disclosure of the prior application is hereby incorporated by reference herein in its entirety.

### BACKGROUND OF THE INVENTION

1. Field of the Invention

The present invention relates generally to a protection technique for a computer system, and more particularly to a protection system and method that integrates the static scan technique and the dynamic intercept technique in a computer system.

2. Description of Prior Art

The protection for the computer system is an important issue for a computer user at present. Chain mails for the spread of virus by way of Internet are increasingly overabundance in virtue of vigorous development of network. Modern people get used to E-mails (electronic mails) as the connecting interface between human beings. Afterwards, they often receive greetings and messages sent out from others, as well as the annoying spam. Further, it is impossible to guard against viruses smuggled by concealing in between the mails.

Computer viruses are buried or hidden in another program. Once the program is executed, the virus is activated and attaches itself to other programs in the system. Nowadays, viruses are frequently spread by the smuggling with files in a predetermined form, such as *.EXE, *.DOC, and *.ZIP form attached to the e-mails. When the user is ignorant of what happened and operates the attached files, the computer will be affected by poison. Viruses will send themselves to the entire mailing list of the users' record of communication. If the users relax their vigilance and operate the virus-smuggled files, there will be a chain-infected reaction that causes the disaster worldwide.

Moreover, for the PC (personal computer) users, they will risk interconnecting of computers into networks. If the viruses infects the users' computers, viruses usually destroy the files throughout the disks and all computer files may be deleted that lose the essential data in the twinkling of an eye and cause the computer system operation out of order. If files in the operating system have been infected and destroyed, the operating system, such as Windows, cannot be rebooted. The more serious effect is that the computer system needs to be setup again. Hence, there is a need for eliminating viruses from computers and networks.

Conventionally, a used backup/recovery software, although having the backup/recovery function, it is capable of executing the backup program for backing up data, also of executing the recovery program for restoring the data to the hard disk (HD), in order to protect the HD with the function of returning to a normal state. For instance, the conventional backup/recovery software, such as the Ghost software developed by Symantec Corporation, needs the network administrator to operate the operating system (OS) before he/she manually operates a backup/recovery program. The Ghost software includes a backup program to back up all data stored in selected partition/hard disk to a file. In addition, it further includes a recovery program to restore the data from the file to the selected partition/hard disk. Prior to backing up the data, the Ghost software stops all other tasks in the computer. All running applications are closed before the backup procedure. It then creates the backup file, with the backed-up data, in a single task procedure. This backup procedure takes about 8 minutes per Gigabyte, in general. Since the Ghost software backs up all the valid data stored in the hard disk, the data itself backed up by the Ghost software occupies an extremely large space in the hard disk. All data provided currently used by the file system of the operating system (OS) will be backed up into the backup file, nevertheless whether such related data has been changed or not in the past, thereby occupying a great amount of space in the hard disk.

Further, some presently available backup/recovery software, such as the Goback software developed by Adaptec Corporation, operates its recovery program without the need of operating the operating system (OS) in advance. While initiating a recovery operation, the Goback software recoveries the hard disk to a selected status. When the computer system is destroyed, the operation of restoring the hard disk also needs the network administrator to implement the recovery program manually.

Obviously, when the computer system is surfing the web or receiving electronic mails by the user, the virus could be easily infect the user's hard disks. The virus will then break out that causes the accidental damage of the computer system. Moreover, if the virus is successful, the computer cannot be booted from either the hard disk or the floppy. Nevertheless, the conventional backup/recovery software is unable to effectively distinguish the exact time point of infected by the virus, not to mention the fact that it is incapable of restoring the computer to a normal state exactly prior to being infected by the virus.

### SUMMARY OF THE INVENTION

The present invention provides a protection system and method to resolve the foregoing problems faced by the conventional techniques.

An object of the present invention is to provide a protection system and method, wherein the exact time point of infected by the virus is verified.

In accordance with an aspect of the present invention, a protection system is installed in a computer system. The computer system has a detecting module. The detecting module detects virus, spyware, Trojan or other security threats. The protection system comprises at least a storage space, a searching module and a backup/recovery module. The storage space is used for recoding a message of operation to a file within the computer system. The searching module is coupled to the storage space. The searching module is used for searching the message of the file. The backup/recovery module is coupled to the searching module. The backup/recovery module is used for restoring the computer system to a previous state in accordance with the message.

In the preferred embodiment of the invention, the protection system further comprises a monitoring module for monitoring a create operation to the file. The protection system further comprises a monitoring module for monitoring a change operation to the file. A file list is generated in the storage space. The file list records a file name and time information. The file list records daily or at anytime. The file list may record according to time schedule as well.

In accordance with another aspect of the present invention, another protection system is installed in a computer system. The computer system has a detecting module and a storage space. The detecting module detects virus, spyware, Trojan or other security threats. The storage space records a message of operation to a file within the computer system. The protection system comprises at least a searching module and a backup/recovery module. The searching module is coupled to the storage space. The searching module is used for searching the message of the file. The backup/recovery module is coupled to the searching module. The backup/recovery module is used for restoring the computer system to a previous state in accordance with the message.

In the preferred embodiment of the invention, the protection system further comprises a monitoring module for monitoring a create operation to the file. The protection system further comprises a monitoring module for monitoring a change operation to the file. A file list is generated in the storage space. The file list records a file name and time information. The file list records daily or at anytime. The file list may record according to time schedule as well.

The present invention may best be understood through the following description with reference to the accompanying drawings, in which:

### BRIEF DESCRIPTION OF THE DRAWINGS

FIG. 1 shows a schematic block diagram of a protection system of a preferred embodiment according to the present invention.

FIG. 2 shows a schematic flow chart of a recoding method of the preferred embodiment according to the present invention.

FIG. 3 shows a schematic flow chart of a recovery method of the preferred embodiment according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes a new technique to integrate the static scan technique and the dynamic intercept technique in a computer system.

According to the preferred embodiment of the present invention, a protection system is installed in a computer system. The computer system has a detecting module. The detecting module detects virus, spyware, Trojan or other security threats. The protection system comprises at least a storage space, a searching module and a backup/recovery module. The storage space is used for recoding a message of operation to a file within the computer system. The searching module is coupled to the storage space. The searching module is used for searching the message of the file. The backup/recovery module is coupled to the searching module. The backup/recovery module is used for restoring the computer system to a previous state in accordance with the message.

The protection system further comprises a monitoring module for monitoring a create operation to the file. The protection system further comprises a monitoring module for monitoring a change operation to the file. A file list is generated in the storage space. The file list records a file name and time information. The file list records daily or at anytime. The file list may record according to time schedule as well.

According to the preferred embodiment of the present invention, there is another protection system installed in a computer system. The computer system has a detecting module and a storage space. The detecting module detects virus, spyware, Trojan or other security threats. The storage space records a message of operation to a file within the computer system. The protection system comprises at least a searching module and a backup/recovery module. The searching module is coupled to the storage space. The searching module is used for searching the message of the file. The backup/recovery module is coupled to the searching module. The backup/recovery module is used for restoring the computer system to a previous state in accordance with the message.

Another protection system further comprises a monitoring module for monitoring a create operation to the file. The protection system further comprises a monitoring module for monitoring a change operation to the file. A file list is generated in the storage space. The file list records a file name and time information. The file list records daily or at anytime. The file list may record according to time schedule as well.

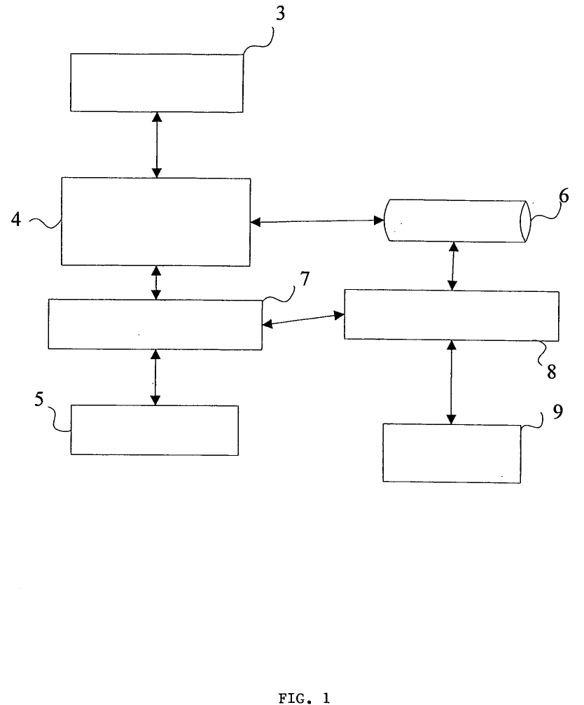

Referring to FIG. 1, a schematic block diagram of a protection system of a preferred embodiment according to the present invention is shown. The protection system of the present invention is suitable for a computer system, which records attribute messages of files. The computer system has a detecting module 7, which detects virus, spyware, Trojan or other security threats.

The protection system includes at least a storage space 6, a processing module and a backup/recovery module 9. The storage space 6 is used for recoding a message of operation to a file within the computer system. The storage space may be located in the computer system alternatively. The processing module is coupled to the storage space. The processing module is used for searching the message of the file. The processing module comprises a monitoring module 4 and a scanning module 8. The backup/recovery module 9 is coupled to the processing module. The backup/recovery module 9 is used for restoring the computer system to a previous state in accordance with the message.

The monitoring module 4 intercepts data communicated between user application program 3 and file system 5 and monitors a create operation or a change operation to the file. Message of files, such as file name, time information and change message of files are kept in a file list generated in the storage space 6. The file list records daily or at anytime. The file list may record according to time schedule as well.

The detecting module 7 informs the scanning module 8 upon virus, spyware, Trojan or other security threats is detected. The scanning module 8 scans the storage space 6 and finds message of files. Operation to the file and time information can be retrieved to assure the virus-infected time point. The backup/recovery module 9 restores the computer system to a previous state in accordance with the message.

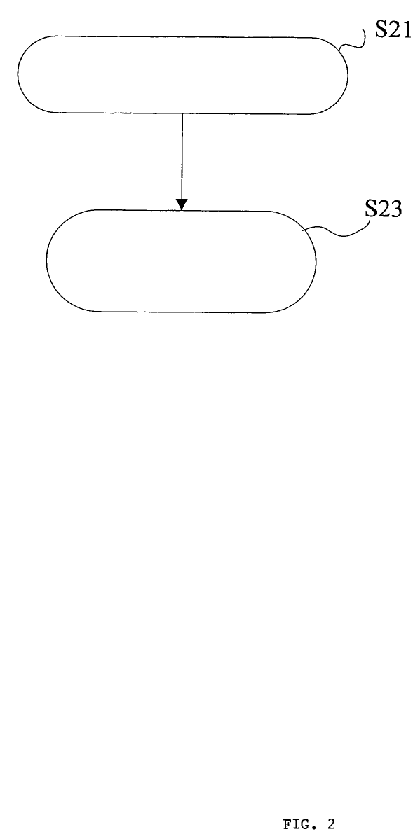

Referring to FIG. 2, a schematic flow chart of a recoding method of the preferred embodiment according to the present invention is shown. According to the present invention, the recoding method of the present invention is suitable for a computer system. In step S21, the monitoring module intercepts a create operation or a change operation to the file. In step S23, the file name and current time information are kept in a file list.

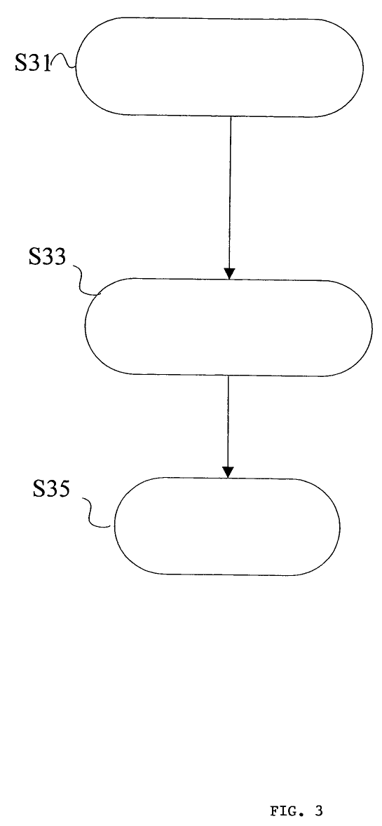

Referring to FIG. 3, a schematic flow chart of a recovery method of the preferred embodiment according to the present invention is shown. According to the present invention, the recovery method of the present invention is suitable for a computer system. In step S31, the detecting module informs the scanning module 8 upon virus, spyware, Trojan or other security threats is detected. In step S33, the scanning module scans the storage space 6 and finds message of files. Operation to the file and time information can be retrieved to assure the virus-infected time point. In step S35, the backup/recovery module restores the computer system to a previous state in accordance with the message.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A protection system, which is installed in a computer system having a detecting module, said detecting module detecting virus, spyware, Trojan or other security threats, said protection system comprising:
a storage space for recoding a message of operation to a file within said computer system;
a processing module coupled to said storage space for searching said message of said file; and
a backup/recovery module coupled to said processing module for restoring said computer system to a previous state in accordance with said message.

2. The protection system according to claim 1, further comprising a monitoring module for monitoring a create operation to said file.

3. The protection system according to claim 1, further comprising a monitoring module for monitoring a change operation to said file.

4. The protection system according to claim 1, wherein a file list is generated in said storage space.

5. The protection system according to claim 4, wherein said file list records a file name and time information.

6. The protection system according to claim 4, wherein said file list records daily.

7. The protection system according to claim 4, wherein said file list records anytime.

8. The protection system according to claim 4, wherein said file list records according to time schedule.

9. A protection system, which is installed in a computer system having a detecting module and a storage space, said detecting module detecting virus, spyware, Trojan or other security threats, said storage space recording a message of operation to a file within said computer system, said protection system comprising:
a processing module coupled to said storage space for searching said message of said file; and
a backup/recovery module coupled to said processing module for restoring said computer system to a previous state in accordance with said message.

10. The protection system according to claim 9, further comprising a monitoring module for monitoring a create operation to said file.

11. The protection system according to claim 9, further comprising a monitoring module for monitoring a change operation to said file.

12. The protection system according to claim 9, wherein a file list is generated in said storage space.

13. The protection system according to claim 12, wherein said file list records a file name and time information.

14. The protection system according to claim 12, wherein said file list records daily.

15. The protection system according to claim 12, wherein said file list records anytime.

16. The protection system according to claim 12, wherein said file list records according to time schedule.

17. The protection system according to claim 1, wherein said operation to said file within said computer system is continuously monitored.

18. The protection system according to claim 9, wherein said backup/recovery module backs up said file prior to changing said file.

19. The protection system according to claim 11, wherein said operation to said file within said computer system is continuously monitored.

20. The protection system according to claim 19, wherein said backup/recovery module backs up said file prior to changing said file.
